(19) United States
(12) Patent Application Publication
(10) Pub. No.: US 2010/0192434 A1
(43) Pub. Date: Aug. 5, 2010

(54) Method and apparatus for mounting signs and other displays

(76) Inventors: Steven E. Smith, Covington, LA (US); Marcel George Peterson, Madisonville, LA (US)

Correspondence Address: TED M. ANTHONY;BABINEAUX, POCHE, ANTHONY & SLAVICH, L.L.C, P.O. DRAWER 52169, LAFAYETTE, LA, 70505-2169, US

(21) Appl. No.: 12/658,067

(22) Filed: Feb. 2, 2010

Related U.S. Application Data
(60) Provisional application No. 61/206,599, filed on Feb. 2, 2009.

(51) Int. Cl. G09F 15/00

(52) U.S. Cl. 40/606.01

(57) ABSTRACT

A street sign mounting assembly including a sign post cap and at least one sign holder bracket. The cap is universally adapted to fit common street sign posts, while the sign holder brackets are designed to hold street signs of varying thicknesses. The cap is coupled to a sign holder bracket using a friction-lock connection assembly. Multiple sign holder brackets are likewise connected to one another using a friction-lock connection assembly.

CROSS REFERENCES TO RELATED APPLICATION: PRIORITY OF U.S. PROVISIONAL PATENT APPLICATION Ser. No. 61/206,599 FILED FEB. 2, 2009, INCORPORATED HEREIN BY REFERENCE, IS HEREBY CLAIMED.

### STATEMENTS AS TO THE RIGHTS TO THE INVENTION. MADE UNDER FEDERALLY SPONSORED RESEARCH AND DEVELOPMENT: NONE

### BACKGROUND OF THE INVENTION

1. Field of the Invention

The present invention relates to a method and apparatus for mounting and displaying street signs and/or other displays on sign posts or poles.

2. Brief Description of the Prior Art

Street identification and traffic signs are well known and in common use with a variety of designs and mounting hardware. In most cases, signs commonly comprise elongated planar surfaces, but can be manufactured having different shapes and thicknesses. For example, some signs may have an overall uniform thickness, while others may be manufactured with thickened edges at their margins. Moreover, street signs are installed and maintained typically by individual municipalities on different types of posts using varying types of mounting assemblies.

Inconsistent mounting configurations frequently make it necessary for maintenance crews to carry a large inventory of street sign mounting hardware. As such, a universally adaptable street sign mounting assembly would greatly reduce the hardware inventory that maintenance crews are required to carry, and that municipalities are required to maintain. Thus, it is desirable to provide a street sign assembly that is not only adaptable to fit a variety of street signs having varying dimensions, but also is one that is adaptable to fit most commonly-used existing street sign posts.

Street signs are also subject to various types of abuse and/or damage, such as from changing weather conditions, theft, and intentional vandalism. Because street signs are used almost exclusively outdoors, varying weather conditions make it essential that the mounting hardware be constructed of strong and durable materials capable of resisting natural forces.

The prior art has provided street sign holder assemblies that attempt to solve the above problems. The street sign holder assemblies most commonly used today are made of die cast aluminum and fastened to a sign post with zinc plated carbon steel screws. This combination of metals frequently causes electrolysis (appearing to be rust) and makes replacement of signs difficult. Moreover, traditional die cast aluminum street sign mounting assemblies require a different post cap for different types of sign posts which tend to have loose tolerances and must be adjusted and held in place with screws. The use of loose fitting mounting hardware and conventional fasteners makes these street sign vulnerable to theft and vandalism. Accordingly, street sign hardware must be manufactured using strong, weather resistant materials and should be beneficially designed to prevent theft and vandalism.

### SUMMARY OF THE PRESENT INVENTION

In its preferred form, the present invention seeks to solve these problems by providing a street sign holder and cap assembly generally comprising a universal cap member, a male sign holder bracket, and a female sign holder bracket.

The cap member of the present invention is universally adapted to fit most common types of street sign posts including, but not necessarily limited to, round posts, square posts, and U-channel posts. In the preferred embodiment, said cap member of the present invention requires no bolts, screws, or fasteners for connection to a sign post. Instead of using such fasteners, the cap of the present invention can be frictionally secured to the top of such sign post using a press/interruption fit.

The sign holder brackets of the present invention are designed to fit both flat and extruded signs of varying thicknesses, and can also accommodate the mounting of two signs oriented back to back.

The cap member of the present invention can be frictionally coupled to a male sign holder bracket using a locking assembly. Said locking assembly can also be utilized to couple multiple male and female sign holder brackets to one another; further, such sign holder brackets can be joined to form a crosspiece (such as in a configuration that is commonly used at an intersection). Such locking assembly provides a concealed connection means which deters theft, in part because the manner in which disassembly and removal of the street signs from a sign post can be accomplished is not readily apparent. Minimal, if any, tools are required to mount a sign or other display using the assembly of the present invention.

It is an object of the present invention to provide a sign post cap that is universally adapted to easily fit the most common types of street sign posts in use today.

It is a particular object of the present invention to provide a street sign assembly adaptable to fit street signs of varying thickness.

It is a further object of the present invention to provide a sign holder bracket capable of accepting both extruded signs and flat signs.

It is another object of the present invention to provide a sign holder assembly having a concealed internal fastening mechanism that is less susceptible to vandalism and theft.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed.

FIG. 1 depicts a perspective view of the sign mounting assembly of the present invention, and prior art posts used in connection with the present invention.

FIG. 2 depicts an exploded perspective view of the sign mounting assembly of the present invention.

FIG. 3 depicts a perspective view of a cap member of the sign mounting assembly of the present invention.

FIG. 4 depicts a bottom perspective view of a cap member of the sign mounting assembly of the present invention.

FIG. 5 depicts a bottom view of a cap member of the sign mounting assembly of the present invention.

FIG. 6 depicts a side section view of a cap member of the sign mounting assembly of the present invention along line 6-6 of FIG. 5.

FIG. 7 depicts a bottom view of a cap member of the sign mounting assembly of the present invention received on a square post.

FIG. 8 depicts a bottom view of a cap member of the sign mounting assembly of the present invention received on a round post.

FIG. 9 depicts a bottom view of a cap member of the sign mounting assembly of the present invention received on a U-channel post in a first configuration.

FIG. 10 depicts a bottom view of a cap member of the sign mounting assembly of the present invention received on a U-channel post in a second configuration.

FIG. 11 depicts a perspective view of a male sign holder bracket of the sign mounting assembly of the present invention.

FIG. 12 depicts a side section view of a male sign holder bracket of the sign mounting assembly of the present invention taken along the line 12-12 of FIG. 13.

FIG. 13 depicts a side view of a male sign holder bracket of the sign mounting assembly of the present invention.

FIG. 14 depicts a perspective view of a female sign holder bracket of the sign mounting assembly of the present invention.

FIG. 15 depicts a side section view of a female sign holder bracket of the sign mounting assembly of the present invention along the line 15-15 of FIG. 16.

FIG. 16 depicts a side view of a female sign holder bracket of the sign mounting assembly of the present invention.

FIG. 17 depicts a perspective view of an alternate embodiment of the sign mounting assembly of the present invention.

FIG. 18 depicts a perspective view of yet another alternate embodiment of the sign mounting assembly of the present invention.

FIG. 19 depicts a perspective view of yet another alternate embodiment of the sign mounting assembly of the present invention.

### DETAILED DESCRIPTION OF A PREFERRED EMBODIMENT OF THE INVENTION

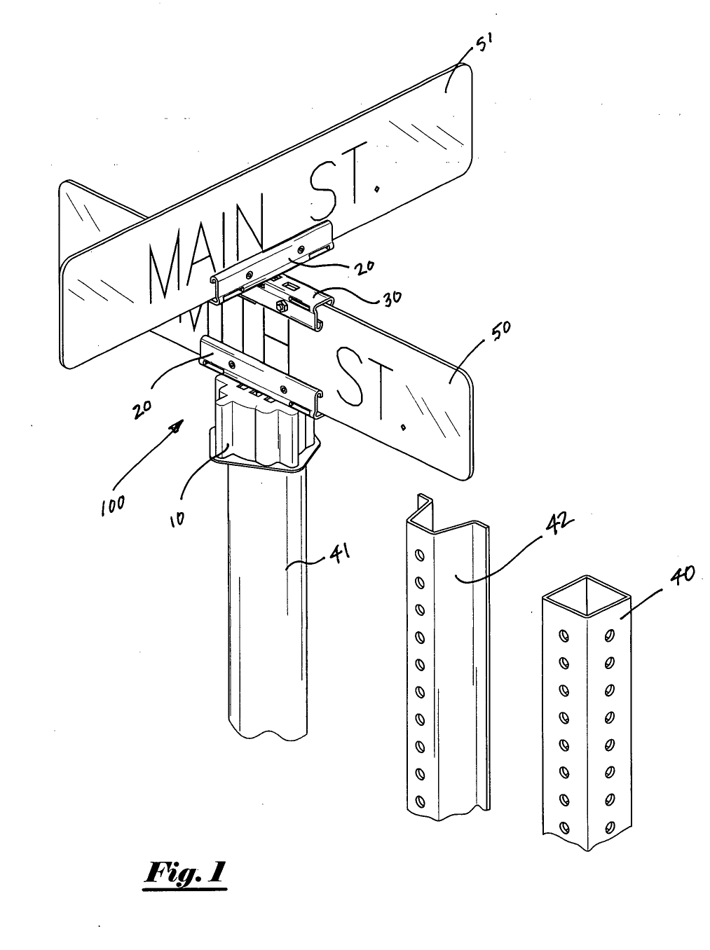

Referring now to the drawings, FIG. 1 depicts a perspective view of mounting assembly 100 according to a preferred embodiment of the present invention. In the configuration depicted in FIG. 1, mounting assembly 100 generally comprises a combination of cap 10, at least two male sign holder brackets 20 and female sign holder bracket 30. The configuration depicted in FIG. 1 generally pertains to a common street sign application such as used at a street intersection, wherein at least two street signs are mounted in perpendicular orientation relative to one another. However, it is to be observed that mounting assembly 100 of the present invention permits mounting of signs or other displays in many different configurations other than the configuration depicted in FIG. 1.

Still referring to FIG. 1, mounting assembly 100 is installed near the upper end of substantially cylindrical sign post 41. However, as more fully described below, mounting assembly 100 of the present invention can also be beneficially mounted on posts having other shapes and sizes, such as U-channel post 42 and substantially rectangular (square) post 40.

Still referring to FIG. 1, cap 10 is received on the upper end of sign post 41. First (lower) male sign holder bracket 20 is attached to said cap 10, as well as the lower portion of first street sign 50, and holds said first street sign 50 securely in place. Female sign holder bracket 30 is attached to the upper portion of first street sign 50.

Second (upper) male sign holder bracket 20 is affixed to female sign holder bracket 30 as well as the lower portion of second street sign 51, and holds said second street sign 51 securely in place.

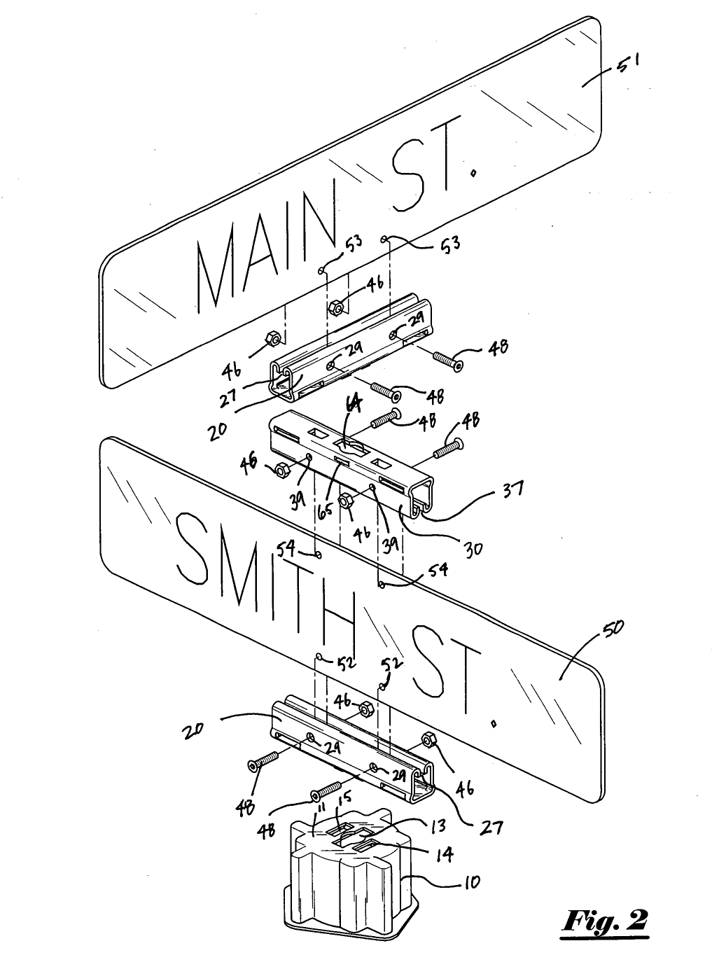

FIG. 2 depicts an exploded perspective view of sign mounting assembly 100 of the present invention. Cap 10 can be received on the upper end of a sign post 42 (not shown in FIG. 2). First (lower) male sign holder bracket 20 is attached to said cap 10, as well as the lower portion of street sign 50, and holds street sign 50 securely in place. Female sign holder bracket 30 is attached to the upper portion of street sign 50. Second (upper) male sign holder bracket 20 is affixed to female sign holder bracket 30 as well as the lower portion of street sign 51, and holds street sign 51 securely in place.

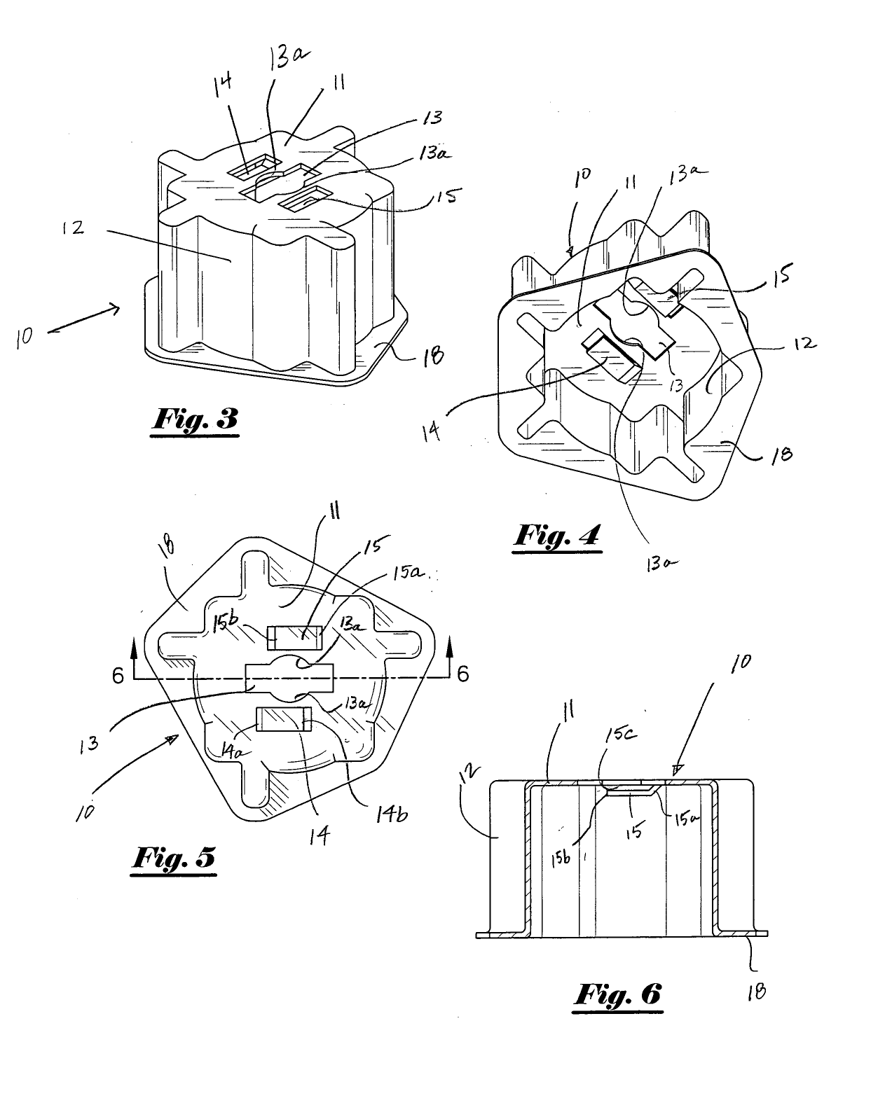

FIG. 3 depicts a perspective view of a cap 10 of the sign mounting assembly 100 of the present invention, while FIG. 4 depicts a bottom perspective view of cap 10. FIG. 5 depicts a bottom view of a cap 10 of the sign mounting assembly 100 of the present invention, while FIG. 6 depicts a side section view of cap 10 along line 6-6 of FIG. 5.

Referring to FIGS. 3 and 4, cap 10 has a substantially planar base 11, wall member 12 extending from said base 11, and substantially planar lower flange 18 extending around wall member 12. Said wall member 12 is generally configured to fit around the upper portions of sign posts as more fully described below. In the preferred embodiment, cap 10 (including, but not necessarily limited to wall member 12) defines a universal profile to permit cap 10 to be received on round posts, square posts, and U-channel posts.

Base 11 includes a cap aperture 13 for connection with a male sign holder bracket 20 as more fully described below. In the preferred embodiment, cap aperture 13 comprises a generally rectangular slot having a circular opening medially positioned within said rectangular slot; said circular opening has a larger diameter than the width of said rectangular slot, thereby defining curved side edges 13a of cap, aperture 13. Referring to FIG. 4, cap 10 further includes first locking projection 14 and second locking projection 15; said first and second locking projections 14 and 15 are beneficially positioned lateral to, and on opposite sides, of cap aperture 13. Further, in the preferred embodiment, said first and second locking projections are offset from one another along the length of cap aperture 13.

Referring to FIG. 5, cap 10 has substantially planar base 11, wall member 12 extending from said base 11 (not visible in FIG. 5), and lower flange 18. Base 11 includes cap aperture 13 having opposing curved side edges 13a. First and second locking projections 14 and 15 are beneficially positioned on opposite sides of cap aperture 13, are offset relative to one another, and extend below substantially planar base 11 into the interior space formed within wall member 12 of cap 10. First locking projection 14 is anchored to base 11 at end 14a but not at end 14b, thereby forming an opening at end 14b. Similarly, second locking projection 15 is anchored to base 11 at end 15a but not at end 15b, thereby forming an opening at end 15b.

FIG. 6 depicts a side section view of cap 10 along line 6-6 of FIG. 5. Cap 10 has substantially planar base 11, wall member 12 extending from said base 11, and lower flange 18. Locking projection 15 extends below substantially planar base 11 into the interior space formed within wall member 12 of cap 10. Locking projection 15 is anchored to base 11 at end 15a but not at end 15b, thereby forming an opening at end 15b. Further, in the preferred embodiment, locking projection 15 is offset from planar base 11, thereby forming gap 15c between locking projection 15 and substantially planar base 11.

The irregular design of wall 12 of cap 10 enables cap 10 to be universally received on most common types of street sign posts. Cap 10 installs on a street sign post with an interruption or press fit, whereby the top of said street sign post is axially received into the interior space defined by said wall 12, thereby causing a gripping engagement between the interior surfaces of said wall 12 and the exterior surface of said street sign post.

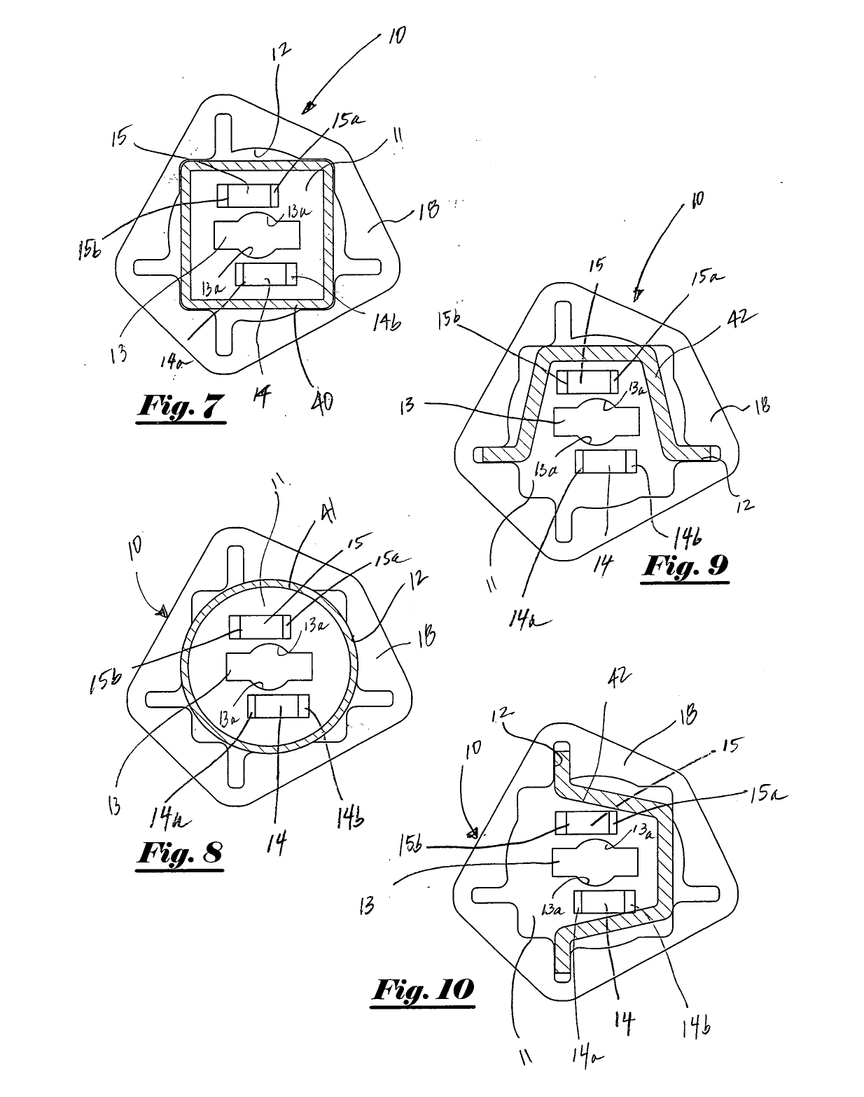

FIG. 7 depicts a bottom view of cap 10 having flange 18 received on a square post 40, gripping the outer surface of said post 40 with the inner surface of wall 12. FIG. 8 depicts a bottom view of cap 10 having flange 18 received on a circular post 41, gripping the outer surface of said post 41 with the inner surface of wall 12. FIG. 9 depicts a bottom view of cap 10 having flange 18 received on a U-channel post 42, gripping the outer surface of said post 42 with the inner surface of wall 12 in a first configuration. FIG. 10 depicts a bottom view of cap 10 having flange 18 received on a u-channel post 42, gripping the outer surface of said post 42 with the inner surface of wall 12.

In each of FIGS. 7-10, cap aperture 13 having opposing curved side edges 13a is disposed through said base 11. First and second locking projections 14 and 15 are beneficially positioned on opposite sides of cap aperture 13, are offset relative to one another, and extend below substantially planar base 11 into the interior space formed within wall member 12 of cap 10. First locking projection 14 is anchored to base 11 at end 14a but not at end 14b, thereby forming an opening at end 14b. Similarly, second locking projection 15 is anchored to base 11 at end 15a but not at end 15b, thereby forming an opening at end 15b.

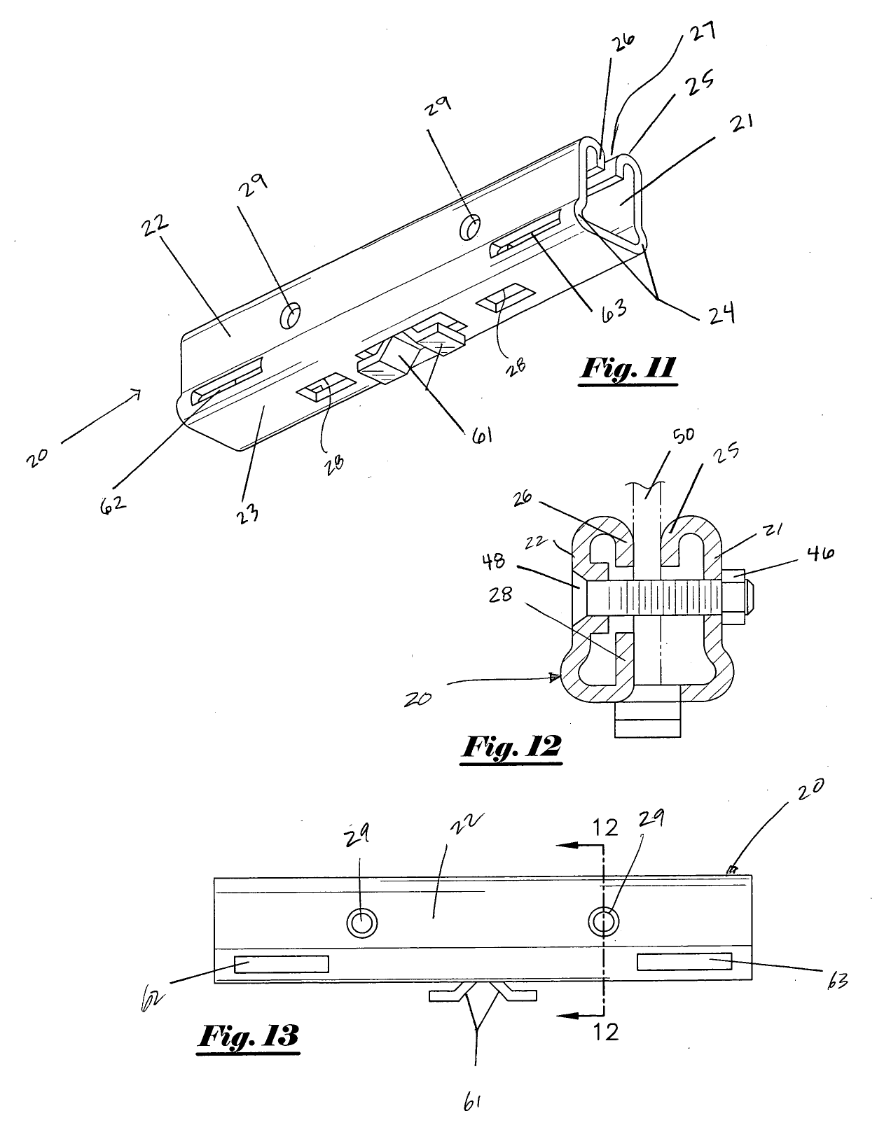

FIG. 11 depicts a perspective view of a male sign holder bracket 20 of the present invention having first side wall 21 and second side wall 22 fixed to bottom 23 along the longitudinal axis of said male sign holder bracket 20. In the preferred embodiment, generally U-shaped male sign holder bracket 20 has a flared base 24 where first and side walls 21 and 22 join said bottom 23.

First and second lips 25 and 26 are formed along the length of first and second side walls 21 and 22, respectively. Said first and second lips 25 and 26 together cooperatively define a channel 27 for receiving and securing a street sign in an upright/vertical position, parallel to the longitudinal axis of male sign holder bracket 20.

Male sign holder bracket 20 further includes a plurality of backing tabs 28 (obscured from view in FIG. 11) projecting upward from bracket bottom 23 into the space formed between first side wall 21 and second side wall 22. As best shown in FIG. 12, upward projecting backing tabs 28 are aligned with second lip 26 to define a vertical plane parallel to the longitudinal axis of the sign holder bracket 20. Referring back to FIG. 11, side walls 21 and 22 further include a plurality of transverse holes 29 for receiving fasteners for securing a sign within channel 27of male sign holder bracket 20. Holes 29 are preferably aligned along the length of male sign holder bracket 20 adjacent to backing tabs 28.

In the preferred embodiment, male sign holder bracket 20 further includes a pair of opposing coupling members 61 projecting downward and outward from the center of bracket bottom 23 along the longitudinal axis of male sign holder bracket 20. In the preferred embodiment, coupling members 61 are preferably stamped or cut out of bracket bottom 23. Male sign holder bracket 20 further includes a plurality of elongate slots 62 and 63 spaced at a distance apart along both sides of the flared base 24.

FIG. 13 depicts a side view of male sign holder bracket 20 along second side wall 22. A plurality of transverse holes 29 is disposed through side wall 22 (as well as side wall 21, although not visible in FIG. 13). Opposing coupling members 61 extend from bracket bottom 23 along the longitudinal axis of male sign holder bracket 20. Elongate slots 62 and 63 are spaced at a distance apart along both sides of the flared base 24.

FIG. 12 depicts a section view of male sign holder bracket 20 taken along line 12-12 of FIG. 13. Sign 50 is received within channel 27. Threaded bolt 48 is inserted through transverse holes 29 in side walls 21 and 22, as well as aligned holes in sign 50. Nut 46 is connected to bolt 48. Tightened nuts 46 and bolts 48 exert inward normal forces against male sign holder bracket 20, frictionally clamping street sign 50 in the channel 27 between first and second lips 25 and 26. Backing tabs 28 of said male sign holder bracket 20 support the lower portion of sign 50, helping to keep the base of sign 50 substantially centered within channel 27.

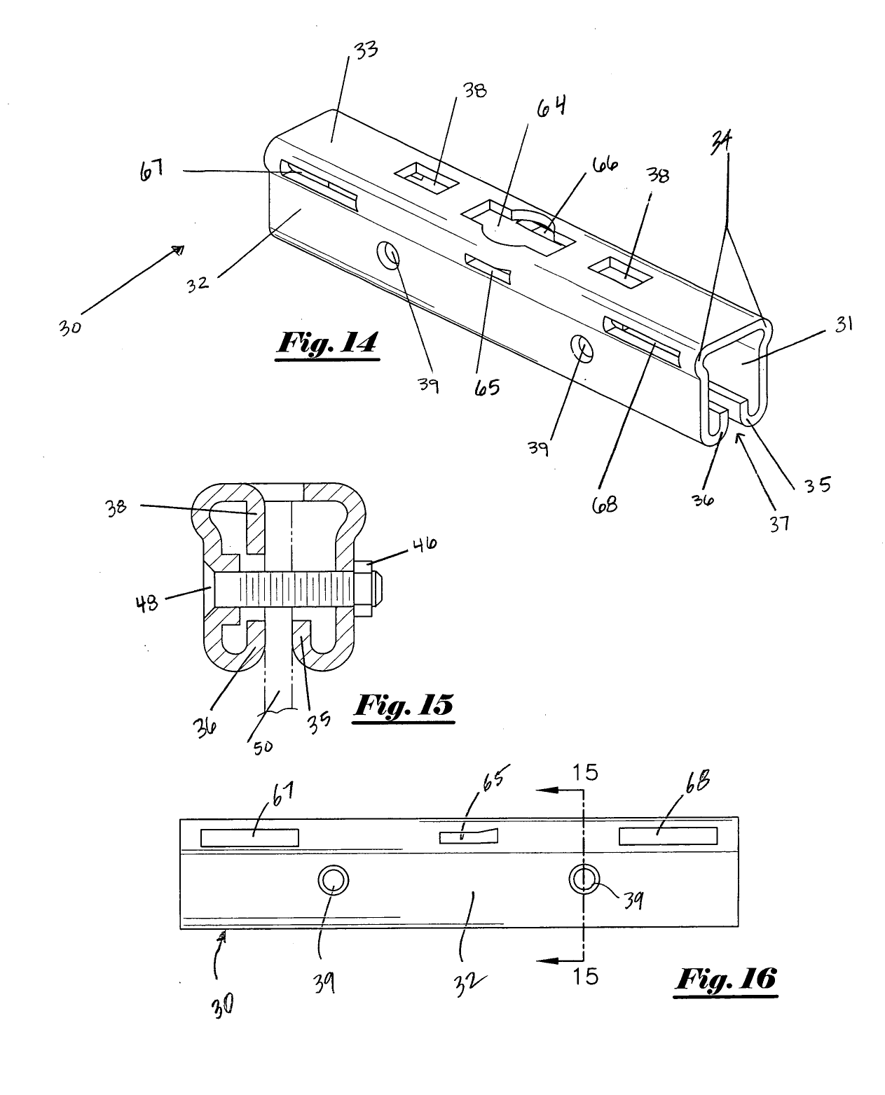

FIG. 14 depicts a female sign holder bracket 30 having a first side wall 31 and a second side wall 32 fixed to a top 33 along the longitudinal axis of said sign holder bracket 30. In the preferred embodiment, generally U-shaped female sign holder bracket 30 has a flared section 34 where side walls 31 and 32 join said top 33.

First and second lips 35 and 36 are formed along the length of first and second side walls 31 and 32, respectively. Said first and second lips 35 and 36 together cooperatively define a channel 37 for receiving and securing a street sign in an upright/vertical position, parallel to the longitudinal axis of female sign holder bracket 30.

Female sign holder bracket 30 further includes a plurality of backing tabs 38 (obscured from view in FIG. 14) projecting downward from bracket top 33 into the space formed between side walls 31 and 32. As best shown in FIG. 15, downward projecting backing tabs 38 are aligned with second lip 36 to define a vertical plane parallel to the longitudinal axis of the female sign holder bracket 30. Referring back to FIG. 14, side walls 31 and 32 further include a plurality of transverse holes 39 for receiving fasteners for securing a sign within channel 37 of female sign holder bracket 30. Holes 39 are preferably aligned along the length of said female sign holder bracket 30 adjacent to backing tabs 38.

In the preferred embodiment, top 33 of female sign holder bracket 30 includes a bracket aperture 64 sized and shaped to receive the coupling members 61 of the male sign holder bracket 30 (aperture 64 being similar in design to cap aperture 13 of cap 10). Bracket aperture 64 comprises a generally rectangular slot having a circular opening medially positioned in said rectangular slot, wherein said circular opening has a larger diameter than the width of said rectangular slot. Elongate slots 65 and 66 are positioned generally adjacent to bracket aperture 64.

FIG. 16 depicts a side view of female sign holder 30 of the present invention. First and second side walls 31 and 32 include a plurality of transverse holes 39 for securing a sign 50 to said female sign holder bracket 30. Holes 39 are preferably aligned along the length of the female sign holder bracket 30 adjacent to backing tabs 38. As also depicted in FIG. 14, female sign holder bracket 30 further includes elongate slot 65 along flared section 34.

FIG. 15 depicts a section view of female sign holder bracket 30 taken along line 15-15 of FIG. 16. Sign 50 is received within channel 37. Threaded bolt 48 is inserted through transverse holes 39 in side walls 31 and 32, as well as complementary aligned holes disposed through sign 50. Nut 46 is connected to bolt 48. When tightened, nuts 46 and bolts 48 exert inward normal forces against female sign holder bracket 30, frictionally clamping street sign 50 in channel 37 between first and second lips 35 and 36 and backing tabs 38 of said female sign holder bracket 30. Backing tab acts to center sign 50 within channel 37.

Referring back to FIG. 2, cap 10 is coupled to a first (lower) male sign holder bracket 20. In use, the coupling members 61 (not visible in FIG. 2) of said first male sign holder bracket 20 are inserted into cap aperture 13 in the base of cap 10. A rotational force is then applied to male sign holder bracket 20. Coupling members 61 extend below base 11 of cap 10, and engage against the opposing locking projections 14 and 15 to securely connect the male sign holder bracket 20 to cap 10.

A second (upper) male sign holder bracket 20 cooperates with female sign holder bracket 30 to form a crosspiece that holds two street signs in perpendicular relationship. Coupling members 61 of said second male sign holder bracket 20 are inserted into the bracket aperture 64 at the top 33 of female sign holder bracket 30. A rotational force is then applied to align the male and female sign holder brackets 20 and 30 in the perpendicular locking position, wherein coupling members 61 of second male sign holder bracket 20 are received within slots 65 and 66 in the flared base of the female sign holder bracket 30. As seen in FIG. 2, the interconnected sign holder brackets cooperate to support the upper sign 51 in a position crosswise to lower sign 50.

Still referring to FIG. 2, bolts 48 are inserted through the holes 29 upper and lower male sign holder brackets 20, and holes 39 of female sign holder bracket 30, as well as complementary screw holes 52, 53, and 54 of signs 50 and 51, respectively. Nuts 46 are threaded on bolts 48, and then tightened to firmly secure the male and female sign holder brackets to signs 50 and 51.

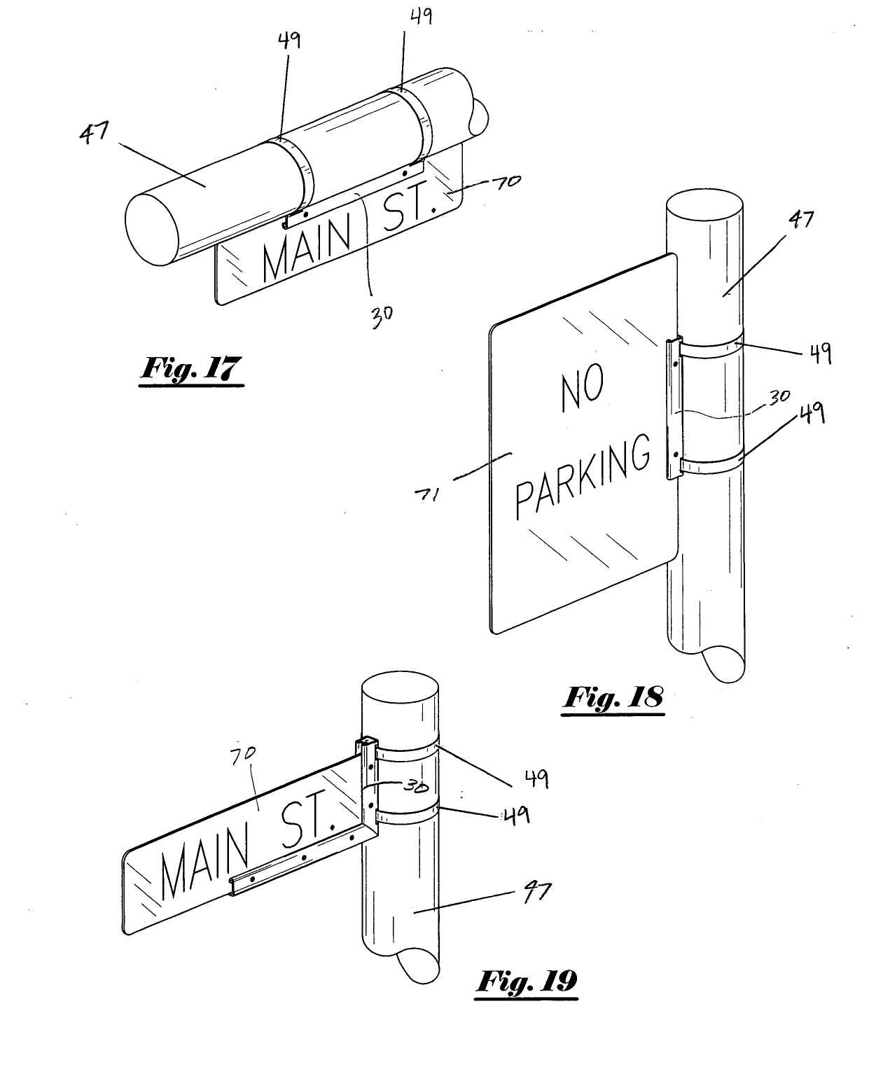

FIGS. 17-19 show alternative embodiments of the present invention. In each embodiment, bands 49 are strapped around a pole 47 and through the slots 62 and 63 and tightened to secure female sign holder bracket 30 to light or power poles or other utility poles 47. Slots 62 and 63 are sized and shaped to receive bands 49 to secure the sign holder bracket 30 to a pole 47. Signs 70 and 71 can be affixed to said female sign holder brackets using nuts and bolts according to the method described in detail above.

In the preferred embodiment, cap and sign holder brackets of the present invention are preferably made of stainless steel with progressive dies. Such manufacturing process eliminates pollution commonly associated with the aluminum smelting process used to manufacture traditional street sign mounting hardware. Moreover, cap and sign holder brackets of the present invention are also designed to minimize scrap; there are little or no side or end (blanks/trimmings) scraps and the only scrap pieces generated are the punched out holes and slots. Stainless steel cap and sign holder brackets are lighter in weight and much stronger than die cast aluminum, and do not require any tapped holes or any other secondary production operations. Accordingly, the present invention provides a universally applicable street sign holder assembly that is strong, dependable, long lasting, lightweight, and easy to install.

Sign holder brackets of the present invention are designed to fit both flat and extruded signs of varying thicknesses and can also accommodate-two signs, mounted back to back (not shown). The sign holder brackets can be manufactured in varying lengths to accommodate signs of any length. A street sign is preferably fastened to a sign holder bracket using stainless steel or aluminum fasteners, eliminating any corrosion problems. Moreover, in an alternative embodiment of the present invention, stainless steel bands are preferably used to secure a sign holder bracket to a pole as depicted in FIGS. 17-19.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A sign mounting assembly comprising:
a. a cap having a base and a wall;
b. a first elongate sign holder bracket frictionally connected to said cap; and
c a second elongate sign holder bracket frictionally connected to said first elongate sign holder bracket.
